(19) United States
(12) Patent Application Publication
(10) Pub. No.: US 2012/0079538 A1
(43) Pub. Date: Mar. 29, 2012

(54) Systems and Methods for Filtering Access to Content During Selected Time Periods

(75) Inventor: Dale Llewelyn Mountain, Silsden (GB)

(73) Assignee: Eldon Technology Limited, Steeton (GB)

(21) Appl. No.: 12/889,218

(22) Filed: Sep. 23, 2010

(51) Int. Cl. H04N 5/445

(52) U.S. Cl. 725/45

(57) ABSTRACT

Provided herein are techniques for controlling access to content during specified time periods. A time period and content filtering parameter specify access to controlled access to content. An entertainment device is configured to disallow access to content outside of the time period and allow access to the content within the time period.

### BACKGROUND

Television receivers, such as satellite and cable television receivers, often include an electronic programming guide that displays lists of available content for immediate or future viewing. Certain types of content, such as adult themed programming, may be inappropriate for viewing by children. Depending on the type of programming, a parent may want to place various access controls on such content. For example, a parent may want to completely block access to pornography, but may still want “TV MA” rated movies available for the parent's own personal viewing. Nonetheless, the parent may not want the child to become aware of the existence of such available content via the television receiver. Some television receivers allow users to lock certain channels such that a child may not see the availability of the programs in the electronic programming guide. However, such systems require a user to unlock the channels when they want to view any of the locked content or any of the associated information in the electronic programming guide. Unlocking programming each time may be an inconvenience for the parent. Furthermore, the user may inadvertently leave the television receiver unlocked. Thus, if a child subsequently uses the television receiver, the previously unlocked content may now be available to the child for viewing. Therefore, more convenient techniques are desired that balance disallowing a child's or other user's access to content while allowing the parent/user to easily access such content as desired.

### BRIEF DESCRIPTION OF THE DRAWINGS

The same number represents the same element or same type of element in all drawings.

FIG. 1 illustrates an embodiment of a communication network.

FIG. 2 illustrates an embodiment of a television receiver of FIG. 1.

FIG. 3 illustrates a method for generating a content selection menu.

FIG. 4 illustrates a method for controlling access to content.

### DETAILED DESCRIPTION OF THE DRAWINGS

Described herein are systems, methods and apparatus for controlling access to content. More particularly, described herein are systems, methods and apparatus for controlling access to content based on a time of the request for access to the content. In at least one embodiment, a user may specify time periods for which access to portions of content are restricted. During a specified time period, an entertainment device disallows access to portions of content. Outside the specified time period, the entertainment device allows access to the content. Alternatively, the user may specify time periods for which access to the content is permitted. Outside of the time periods, access to the content is disallowed by the entertainment device.

As used herein, a content selection menu refers to any type of interface allowing a user to select content for viewing/playback. Content may be video, audio, audio/video or the like. In one embodiment, a content selection menu comprises an electronic programming guide, allowing a user to view and/or select television broadcast programming. However, content selection menus may also include video-on-demand selection menus, digital video recorder (DVR) selection menus, audio content selection menus (e.g., internet radios, MP3 playback systems), internet streaming video selection menus, selection menus of locally stored content or any combination thereof.

In at least one embodiment, content comprises electronic programming guide information associated with one or more programs. During specified time periods, portions of the electronic programming guide are filtered during output by an entertainment device. For example, adult themed programming may be filtered from the electronic programming guide between the hours of 10:00 P.M. and 5:00 A.M. If a child accesses an electronic programming guide at 8:00 P.M., then the entertainment device filters the adult themed programming from the electronic programming guide. However, if the parent accesses the electronic programming guide at 10:30 P.M., then the entertainment device includes the adult themed programming in the electronic programming guide.

In at least one embodiment provided herein, the entertainment device controls access to television programming during specified time periods. For example, if the user requests to access a particular channel prior to 10:00 P.M., then the entertainment device disallows access to the specified channel. However, if the user requests access to the particular channel after 10:00 P.M., then the entertainment device allows access to the specified channel.

At least one embodiment provides a method for generating a content selection menu. The method comprises receiving a request to view the content selection menu and identifying a set of content selection menu information identifying multiple portions of content. The method further includes identifying a first time of the request and identifying a second time associated with a content filtering parameter. Responsive to determining whether the first time is chronologically prior to a second time, the method includes filtering the set of content selection menu information based on the content filtering parameter to remove at least one portion of content if the first time is prior to the second time and outputting the content selection menu with the portion of content removed from the content selection menu information.

Another embodiment provides an entertainment device operable to output a content selection menu, such as an electronic programming guide and/or a listing of recorded, stored or on-demand accessible content. The entertainment device comprises a communication interface operable to receive content, an input interface operable to receive user input requesting to view a content selection menu and control logic communicably coupled to the communication interface and the input interface. The control logic is operable to identify a set of content selection menu information identifying the content, identify a request time associated with the user input and identify a time range associated with a content filtering parameter. The control logic is further operable to determine whether the first time is within the time range and filter the set of content selection menu information to remove a portion of content if the first time is not chronologically within the time range. The control logic then outputs the content selection menu, with the portion of content removed from the content selection menu information, for presentation by an associated presentation device.

Another embodiment provides an entertainment device operable to control access to content. The entertainment device comprises a communication interface operable to receive content, an input interface operable to receive user input requesting to view a requested portion of the content and control logic communicably coupled to the communication interface and the input interface. The control logic is operable to identify a request time associated with the user input, identify a time range associated with a content filtering parameter and determine whether the first time occurs chronologically within the time range. The control logic is further operable to disallow output of the requested portion of content based on the content filtering parameter if the first time is chronologically within the time range and output the requested portion of content if the first time is not chronologically within the time range.

The techniques illustrated herein will be described in the context of a television receiver. However, it is to be appreciated that the techniques may be applied to any type of entertainment device operable to control access to content and/or present content selection menus to a user. For example, the techniques may be applied to radios, audio playback devices, media servers, IPTV servers and the like.

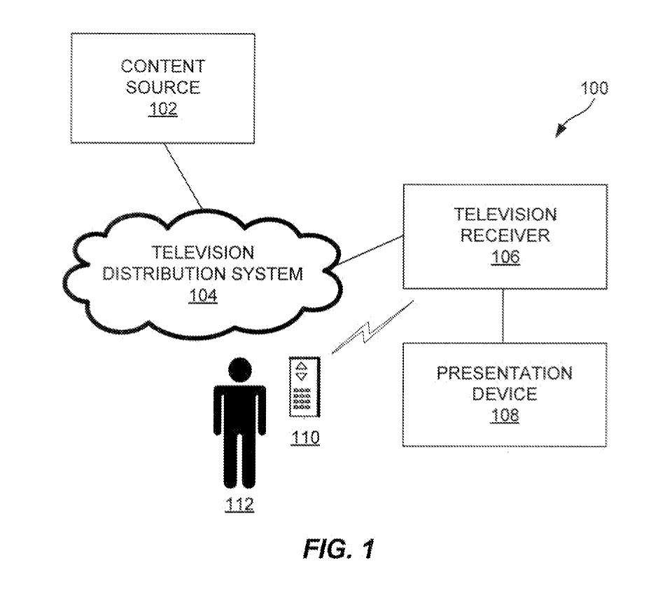

FIG. 1 illustrates an embodiment of a communication network 100. The communication network includes a content source 102, a television distribution system 104, a television receiver 106, a presentation device 108 and a remote control 110. Each of these components will be discussed in greater detail below. The communication network 100 may include other components, elements or devices not illustrated for the sake of brevity.

The content source 102 is operable for receiving, generating and communicating content to one or more television receivers 106. The content to be received, processed, outputted and/or communicated may come in any of various forms including, but not limited to, audio, video, data, information, or otherwise. In at least one embodiment, the content source 102 is operable for receiving various forms and types of content from other sources, aggregating the content and transmitting the content to the television receiver 106 through the television distribution system 104. It is to be appreciated that the content source 102 may receive practically any form and/or type of information from one or more sources including streaming television programming, recorded audio or video, electronic programming guide data and the like.

The television distribution system 104 is operable to transmit content from the content source 102 to the television receiver 106. The television distribution system 104 may comprise any type of wired (e.g., cable and fiber) and/or wireless (e.g., cellular, satellite, microwave, and other types of radio frequency) communication medium and any desired network topology (or topologies when multiple mediums are utilized). Exemplary television distribution systems 104 include terrestrial, cable, satellite and internet protocol television distribution systems. In at least one embodiment, the television distribution system 104 broadcasts or multicasts content to a plurality of television receivers 106. The television distribution system 104 may also distribute content to a specific addressable television receiver 106, such as video-on-demand content and the like. In at least one embodiment, the content source 102 may be embodied as a transmission facility of the television distribution system 104. Exemplary content sources 102 include over-the-air (OTA) terrestrial transmission facilities, cable television distribution head-ends, satellite television uplink centers, broadband or internet servers and the like. The television distribution system 104 may also distribute non-video content, such as electronic programming guide data and the like which is processed by the television receiver 106.

The television receiver 106 is operable to receive content from the television distribution system 104 and output the received content for presentation by the presentation device 108. In at least one embodiment, the presentation device 108 is a display device (e.g., a television) configured to display content to a user 112. The television receiver 106 may receive an audio/video stream in any format (e.g., analog or digital format) and output the audio/video stream for presentation by the presentation device 108. In at least one embodiment, the television receiver 106 is a set-top box (e.g., a satellite television receiver, cable television receiver, terrestrial television receiver, internet protocol television receiver or any other type of receiver/converter box) or other similar device that processes and provides one or more audio and/or video output streams to the presentation device 108 for presentation to the user 112. The television receiver 106 may be further configured to output menus and other information that allow the user 112 to control the output of audio/video content by the television receiver 106, view electronic programming guides, set recording timers and the like.

The presentation device 108 may comprise any type of device capable of receiving and outputting a video signal in any format. Exemplary embodiments of the presentation device 108 include a television, a computer monitor, a liquid crystal display (LCD) screen, a touch screen and a projector. The presentation device 108 and the television receiver 106 may be communicatively coupled through any type of wired or wireless interface. For example, the presentation device 108 may be communicatively coupled to the television receiver 106 through a coaxial cable, component or composite video cables, an HDMI cable, a VGA or SVGA cable, a Bluetooth or WiFi wireless connection or the like. In some embodiments, the television receiver 106 and the presentation device 108 may be integrated as a device combining the functionality of a display device and a television receiver, such as a television with integrated CableCard functionality.

The user 112 may control the television receiver 106 using a remote control 110 or other type of data input device compatible with the television receiver 106. The remote control 110 may comprise any system or apparatus configured to remotely control the output of content by the television receiver 106. For example, the remote control 110 may include buttons for receiving input from the user 112. In at least one embodiment, the remote control 110 includes a touch pad for receiving input from the user 112. The remote control 110 may minimally include a transmitter, an input device (e.g., a keypad) and a processor or control logic for controlling the operation of the remote control 110. The remote control 110 may communicate commands to the television receiver 106 requesting to playback content, chronologically move through content (e.g., fast-forward or reverse), adjust the volume, access electronic programming guides, set or edit recording timers, edit preferences of the television receiver 106 and the like. In some embodiments, the remote control 110 may additionally be configured to remotely control the presentation device 108. The remote control 110 may communicate with the television receiver 106 and/or the presentation device 108 through any type of wireless communication medium, such as infrared (IR) signals or radio-frequency (RF) signals.

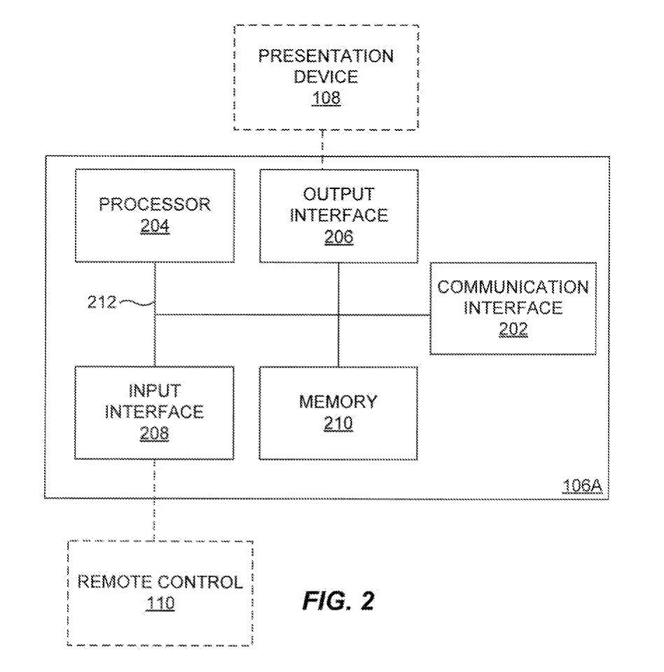

FIG. 2 illustrates an embodiment of a television receiver 106 of FIG. 1. The television receiver 106A includes a communication interface 202, a processor 204, an output interface 206, an input interface 208 and a memory 210. The components of the television receiver 106A may be communicatively coupled together by one or more data buses 212 or other type of data connections.

The communication interface 202 is operable to receive content and other data from the television distribution system 104. More particularly, in at least one embodiment, the communication interface 202 receives and tunes a television signal including television programming. The communication interface 202 may receive an over-the-air (OTA) broadcast, a direct broadcast satellite signal, a cable television signal or an IPTV signal and tune the content to extract the selected television programming. In at least one embodiment, the communication interface 202 may comprise multiple tuners, utilized by the television receiver 106A to output and/or record multiple television programs simultaneously.

The processor 204 is operable for controlling the operation of the television receiver 106A. As used herein, processor 204 refers to a single processing device or a group of inter-operational processing devices. The operation of processor 204 may be controlled by instructions executable by processor 204. Some examples of instructions are software, program code and firmware. Various embodiments of processor 204 include any sort of microcontroller or microprocessor executing any form of software code. The processor 204 controls the reception of data/content by the communication interface 202 and the output of video content by the output interface 206. In at least one embodiment, the processor 204 is operable to generate content selection menus, such as electronic programming guide menus, for presentation by the presentation device 108.

The processor 204 is communicatively coupled to the memory 210, which is operable to store data during operation of the processor 204. Such data may include software and firmware executed by the processor 204 as well as system and/or program data generated during the operation of the processor 204. Memory 210 may comprise any sort of digital memory (including any sort of read only memory (ROM), RAM, flash memory and/or the like) or any combination of the aforementioned.

In at least one embodiment, the television receiver 106A optionally includes a storage medium operable to persistently store video signals recorded by the television receiver 106A. The storage medium may comprise any type of non-volatile memory appropriate for storing video signals recorded by the television receiver 106A. Exemplary storage mediums include hard drives (e.g., magnetic memory), flash memory, battery backed up memory and the like. In at least one embodiment, the storage medium may be internally located within the television receiver 106A. In other embodiments, the storage medium may be located external with respect to the television receiver 106A. The television receiver 106A may also utilize a combination of internal and external storage mediums for storage of video signals. In a recording mode, the processor 204 is operable to control the reception of content by the output interface 206 and storage of the content onto the storage medium. The processor 204 may then generate content selection menus allowing the user 112 to select recorded content for playback via the presentation device 108.

The television receiver 106A also includes an output interface 206 operable to interface with the presentation device 108. More particularly, the output interface 206 is operable to output information for presentation by the presentation device 108 (see FIG. 1). The output interface 206 may be operable to output any type of presentation data to the presentation device 108, including audio data, video data, audio/video (A/V) data, textual data, imagery or the like. In other embodiments, the output interface 206 may comprise a network interface operable to transmit data to other components, devices or elements, such as other computers, servers and the like. The output interface 206 may receive data from the processor 204 and/or other components of the television receiver 106A for output to the presentation device 108 (see FIG. 1).

In at least one embodiment, the output interface 206 may include multiple output connections operable to transmit data to the presentation device 108 in multiple formats through multiple communication mediums. For example, the output interface 206 may include a modulator operable to modulate data onto an NTSC channel for transmission to the presentation device 108 through a coaxial cable. In other embodiments, the output interface 206 may include composite or component outputs which communicatively couple to similar outputs of the presentation device 108 through appropriate cabling. In at least one embodiment, the output interface 206 comprises a High Definition Multimedia Interface (HDMI) that outputs high definition content to the presentation device 108.

In at least one embodiment, the output interface 206 bi-directionally communicates with the presentation device 108. For example, an HDMI port is capable of bi-directionally communicating with the presentation device 108. The output interface 206 may receive various types of data from the presentation device 108 over the bi-directional communication link. For example, the presentation device 108 may transmit information identifying itself and/or its capabilities to the output interface 206. Other bi-directional communication links, such as Ethernet, WiFi, IEEE 1394, USB and the like are also possible in accordance with various embodiments.

The input interface 208 is operable to interface with one or more input devices, such as the remote control 110 (see FIG. 1). The input device may comprise any type of device for inputting data to the television receiver 106A. More particularly, data received from the input device may be used to control the operation of the processor 204 and/or the output of data to the presentation device 108. The input interface 208 and the remote control 110 may be communicatively coupled using any type of wired or wireless connection, including USB, WiFi, infrared and the like. In some embodiments, the input interface 208 may comprise a wireless receiver for receiving any type of RF or IR communication from the remote control 110. Exemplary input devices include keyboards, mice, buttons, joysticks, microphones, remote controls, touch pads and the like.

In accordance with at least one embodiment, the communication interface 202 receives electronic programming guide data from the television distribution system 104. The electronic program guide data identifies television programs and/or television channels which are being currently broadcasted and/or programs which are to be broadcast in the near future. The user 112 may then select programs for viewing, recording or the like. In at least one embodiment, the electronic programming guide may identify metadata regarding a program, such as title, description, genre, actors/actresses, screenwriter, director and/or maturity rating. Some of the aforementioned metadata may also be available to describe particular channels specified in the electronic programming guide. For example, a particular channel may be specified as a “TV MA” maturity rating all the time or may be specified as a “TV MA” maturity rating during specific time periods, such as 10:00 P.M. to 1:00 A.M.

In at least one embodiment, the processor 204 is operable to filter a content selection menu, such an electronic programming guide output, during specified time periods, removing portions of content which may be objectionable to users that may access the content selection menu during the specified time period. For example, a parent may desire for “TV MA” rated programming to be filtered from the electronic programming guide prior to 10:00 P.M. Likewise, a parent may not want “TV MA” recorded programming to be available in a DVR menu of recorded content prior to 10:00 P.M. Thus, when a child utilizes the television receiver 106A earlier in the evening, the child is not made aware of the existence of objectionable content available through the television receiver 106A, regardless of the time the objectionable content is available.

Initially, a user 112, such as a parent, sets up a content filtering parameter on the television receiver 106A. For example, the parent may specify a content filtering parameter to filter programming which is “TV MA”. Furthermore, such content filtering parameter may specify a time range associated with the content filtering parameter. For example, the user 112 may specify a time range of 6:00 A.M. to 10:00 P.M. for application of the content filtering parameter by the television receiver 106A. In other words, the television receiver applies the content filtering parameter during the hours of 6:00 A.M. and 10:00 P.M. Alternatively, the user 112 may specify a time range that the television receiver 106A does not apply the content filtering parameter (e.g., specify the time range 10:00 P.M. to 6:00 A.M.).

The user 112 may specify any number of content filtering parameters, such as maturity ratings, channel identifiers, program identifiers, genres, keywords and the like. For example, in one embodiment, the user 112 may desire for the content filtering parameter to apply to a movie channel which often shows objectionable content that the user 112 desires to be removed from the electronic programming guide during a specified time range.

In at least one embodiment, the content filtering parameter may specify particular types of programming that the user 112 desires to be shown during a specified time period. For instance, the content filtering parameter may specify children's programming during the hours of 6:00 A.M. and 7:00 P.M. Thus, the processor 204 operates to generate a filtered electronic programming guide that includes children's appropriate programming and excludes non-children's appropriate programming.

During application of the content filtering parameter, the input interface 208 receives a request to view a content selection menu. For example, a user may request to access an electronic programming guide, video on-demand guide, recorded programming menu and the like. The processor 204 operates to identify content selection menu information associated with the content selection menu. For example, the processor 204 may identify electronic programming guide information for one or more programs or may identify a plurality of television programs stored on a storage medium associated with the television receiver 106.

The processor 204 further identifies a time associated with the request. The processor 204 further determines whether the time associated with the request is chronologically prior to a time associated with the content filtering parameter. For example, the request to view the electronic programming guide may be at 7:00 P.M. and the content filtering parameter may specify that the filter is to be performed prior to 10:00 P.M. Thus, since the request time is chronologically prior to the time range associated with the content filtering parameter, the processor 204 applies the filter to remove one or more television programs. The processor 204 then outputs the filtered content selection menu via the output interface for presentation by the presentation device 108.

Thus, in accordance with the techniques described herein, the processor 204 may automatically output a filtered or unfiltered content selection menu, depending on the time a user requests to view the content selection menu. For example, if the threshold time is defined at 10:00 P.M., then at 9:59 P.M., the user 112 will see a filtered electronic programming guide while using the television receiver 106A. However, at 10:01 P.M., the user 112 will see the unfiltered electronic programming guide. This allows the parent to set filters on the television receiver 106A during times when a child is most likely to utilize the television receiver 106A. Further more, the techniques described herein allow a parent to easily access their own desired programming during time ranges when the child is not likely viewing the presentation device 108.

In at least one embodiment, the techniques described herein may also be applied to control access to content (e.g., television programs). For example, the processor 204 may utilize the same or similar content filtering parameters defined above to control a user's 112 access to content when the user 112 requests to view content. One such scenario may occur if the user 112 requests to view content not available in a content selection menu by directly inputting a channel number. The processor 204 identifies the time associated with the channel request and determines whether a content filtering parameter applies to the request based on a time range associated with the content filtering parameter. If the processor 204 determines that the content filtering parameter applies to the request, then the processor 204 disallows output of the requested television program. For example, the processor 204 may output an error message or may switch the output to another specified channel, such as the previous channel, the nearest non-restricted channel or a pre-specified channel. If the processor 204 determines that the content filtering parameter does not apply to the request, then the processor 204 outputs the requested television program (via the output interface) for presentation by the presentation device 108.

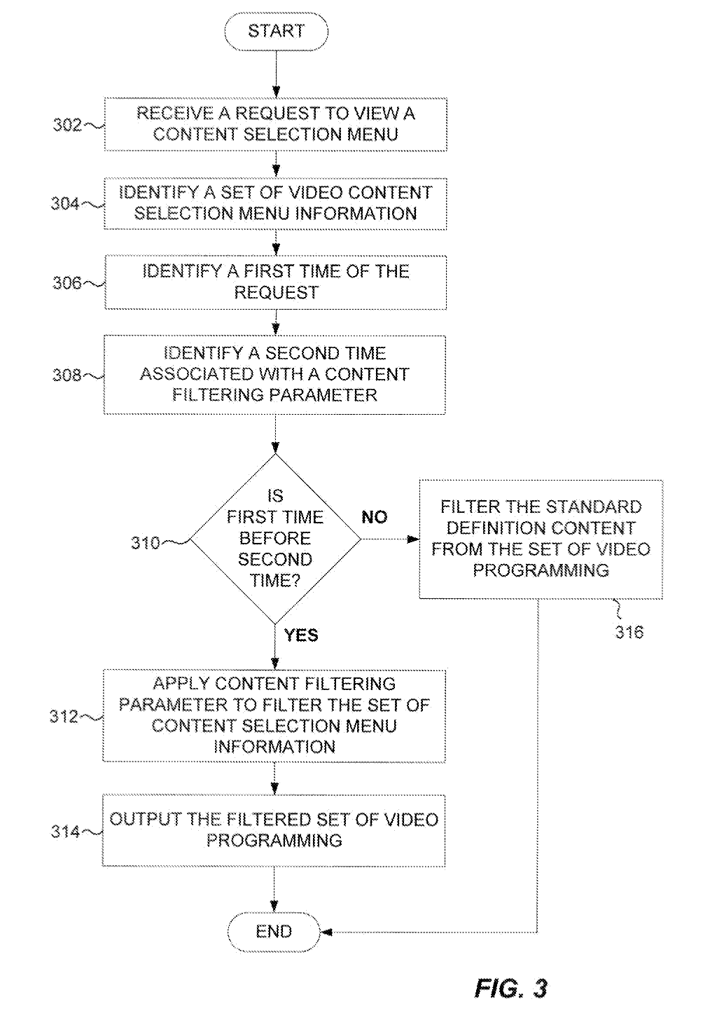

FIG. 3 illustrates a process for generating a content selection menu. The process of FIG. 3 may be operated by any type of device that outputs any type of content selection menu, such as audio, video, audio/video, images and the like. The process of FIG. 3 may include other operations not illustrated for the sake of brevity.

The method includes receiving a request to view the content selection menu (operation 302). For example, a user may request to view a menu of recorded television program available on a DVR. In other embodiments, the user may request to a view electronic programming guide, a video on-demand menu or any combination of the aforementioned content selection menus.

The method further includes identifying a set of content selection menu information identifying a plurality of television programs (operation 304). For example, an entertainment device may identify the television programs stored on a local and/or external storage medium.

The method further includes identifying a first time of the request (operation 306) and identifying a second time associated with a content filtering parameter (operation 308). The first time specifies the current time of the current, e.g., the time the user presses the “guide” or “DVR” button on a remote control. The second time identifies when an entertainment device applies the content filtering parameter. For example, the time may identify when the content selection menu is to be filtered or when the content selection menu is to be presented in an unfiltered format.

The process further includes determining whether the first time is chronologically prior to a second time (operation 310). In at least one embodiment, if the first time is chronologically prior to the second time, then the entertainment device applies the content filtering parameter to the content selection menu in operation 312. In other words, the second time specifies when the content filtering parameter is to be applied. Otherwise, processing continues to operation 316, and the unfiltered content selection menu is output by the entertainment device.

In operation 312, the process includes filtering the set of content selection menu information to remove at least one television program. For example, the entertainment device may filter programs matching a specified content maturity rating. However, as described above, any number of filtering criteria may be applied depending on desired design criteria. In operation 314, the process includes outputting the content selection menu with at least one television program removed from the content selection menu information. In other words, an entertainment device outputs a filtered content selection menu for viewing by a user.

While the above embodiments describe a content filtering parameter that is applied within a specific time range, it is to be appreciated that a content filtering parameter may alternatively be applied outside of a specified time period. In other words, the content filtering parameter specifies when the content filtering parameter is not to be applied by the entertainment device. For example, in operation 312, if the first time is not chronologically prior to the second time, then the entertainment device does not apply the content filtering parameter to the content selection menu. It is to be appreciated that any combination of time ranges may be applied to determine whether to apply a content filtering parameter depending on desired design criteria.

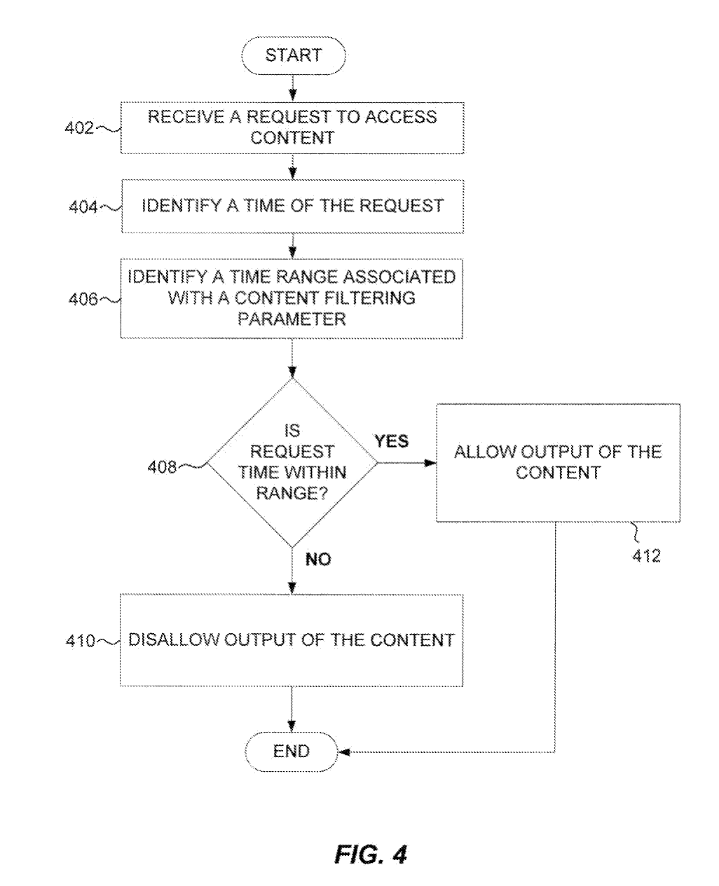

FIG. 4 illustrates a process for controlling access to content. The process of FIG. 4 may be operated to control access to any type of content, such as live or recorded television programs. The process of FIG. 4 may include other operations not illustrated for the sake of brevity.

The process includes receiving user input requesting to view one of a plurality of available television programs (operation 402). For example, a user may specify a particular channel number, such as “300”, requesting to view the content on channel “300”.

The process further includes identifying a, request time associated with the user input (operation 404) and identifying a time range associated with a content filtering parameter (operation 406). As described above, the request time specifies the current local time on an entertainment device and the time range specifies when the entertainment device is set to apply the content filtering parameter (or when the entertainment device is set to not apply the content filtering parameter).

The process further includes determining whether the request time occurs chronologically within the time range (operation 408). If the request time occurs chronologically within the time range, then processing continues in operation 410, and the entertainment device disallows output of the request television program based on the content filtering parameter. In other words, if the content filtering parameter applies to the requested television program during the time range, then the entertainment device disallows output of the requested television program. Otherwise, processing continues to operation 412 and the entertainment device outputs the requested television program if the content filtering parameter does not apply to the requested television program.

Although specific embodiments were described herein, the scope of the invention is not limited to those specific embodiments. The scope of the invention is defined by the following claims and any equivalents therein.

What is claimed is:

1. A method for generating a content selection menu, the method comprising:
receiving a request to view the content selection menu;
identifying a set of content selection menu information identifying content;
identifying a first time of the request;
identifying a second time associated with a content filtering parameter;
determining whether the first time is chronologically prior to a second time;
filtering the set of content selection menu information, based on the content filtering parameter, to remove at least a portion of the content, if the first time is prior to the second time; and
outputting the content selection menu with the portion of content removed from the content selection menu information.

2. The method of claim 1, wherein the content selection menu comprises an electronic programming guide including a plurality of television programs.

3. The method of claim 2, wherein filtering the set of content selection menu information further comprises:
filtering at least one channel from the electronic programming guide based on the content filtering parameter.

4. The method of claim 2, wherein filtering the set of content selection menu information further comprises:
filtering the at least one television program from the electronic programming guide based on the content filtering parameter.

5. The method of claim 4, wherein filtering the at least one television program from the electronic programming guide further comprises:
filtering the at least one television program from the electronic programming guide based on a maturity rating of the at least one television program.

6. The method of claim 4, wherein filtering the at least one television program from the electronic programming guide further comprises:
filtering the at least one television program from the electronic programming guide based on a genre of the at least one television program.

7. The method of claim 1, wherein the content selection menu comprises a menu of stored content.

8. The method of claim 1, further comprising:
outputting the content selection menu, with the at least one television program included in the content selection menu information, if the first time is chronologically after the second time.

9. An apparatus comprising:
a communication interface operable to receive a plurality of television programs;
an input interface operable to receive user input requesting to view a content selection menu; and
control logic communicably coupled to the communication interface and the input interface, the control logic operable to:
identify a set of content selection menu information identifying the plurality of television programs;
identify a request time associated with the user input;
identify a time range associated with a content filtering parameter;
determine whether the first time is within the time range;
filter the set of content selection menu information, to remove at least one television program, based on the content filtering parameter, if the first time is not chronologically within the time range; and
output the content selection menu with the at least one television program removed from the content selection menu information for presentation by an associated presentation device.

10. The television receiver of claim 9, wherein the content selection menu comprises an electronic programming guide.

11. The television receiver of claim 10, wherein filtering the set of content selection menu information further comprises:
filtering at least one channel from the electronic programming guide based on the content filtering parameter.

12. The television receiver of claim 10, wherein filtering the set of content selection menu information further comprises:
filtering the at least one television program from the electronic programming guide based on the content filtering parameter.

13. The television receiver of claim 12, wherein filtering at least one television program from the electronic programming guide based on the content filtering parameter further comprises:
filtering the at least one television program from the electronic programming guide based on a maturity rating of the at least one television program.

14. The television receiver of claim 12, wherein filtering at least one television program from the electronic programming guide further comprises:
filtering the at least one television program from the electronic programming guide based on a genre of the at least one television program.

15. The television receiver of claim 9, wherein the content selection menu comprises a menu of recorded television programming.

16. The television receiver of claim 9, further comprising:
outputting the content selection menu based on the unfiltered set of content selection menu information if first time is chronologically within the time range.

17. A television receiver comprising:
a communication interface operable to receive a plurality of television programs;
an input interface operable to receive user input requesting to view a requested one of the television programs;
control logic communicably coupled to the communication interface and the input interface, the control logic operable to:
identify a request time associated with the user input;
identify a time range associated with a content filtering parameter;
determine whether the first time occurs chronologically within the time range;
disallow output of the requested television program, based on the content filtering parameter, if the request time is chronologically within the time range; and
output the requested television program if the first time is not chronologically within the time range.

18. The television receiver of claim 17, wherein the control logic is operable to disallow output of the requested television program, based further on a television channel associated with the television program.

19. The television receiver of claim 17, wherein the control logic is operable to disallow output of the requested television program based further on a maturity rating associated with the television program.

20. The television receiver of claim 17, wherein the control logic is operable to disallow output of the requested television program based further on a genre associated with the television program.
